(19) United States
(12) Patent Application Publication
(10) Pub. No.: US 2020/0344310 A1
(43) Pub. Date: Oct. 29, 2020

(54) METHOD AND SYSTEM FOR DEPLOYMENT OF EDGE MICROSERVICES

(71) Applicant: EMC IP Holding Company LLC, Hopkinton, MA (US)

(72) Inventor: Stephen James Todd, North Conway, NH (US)

(21) Appl. No.: 16/396,645

(22) Filed: Apr. 27, 2019

(51) Int. Cl. H04L 29/08; H04L 29/06

(52) U.S. Cl. CPC H04L 67/16; H04L 67/42; H04L 67/22; H04L 63/08; H04L 67/306; H04L 67/32

(57) ABSTRACT

A method for managing data includes obtaining, by a data management system, a client request from a client to use a microservice, and, in response to the request: identifying a microservice entry associated with the client request, wherein the microservice entry specifies a microservice, providing a term for the microservice to the client based on the microservice entry, obtaining acceptance of the term from the client, and initiating access between the client and a local data system associated with the microservice based on the acceptance.

### BACKGROUND

Computing devices may include any number of internal components such as processors, memory, and persistent storage. Each of the internal components of a computing device may be used to generate data and to execute functions. The process of generating, storing, and sending data may utilize computing resources of the computing devices such as processing and storage. The utilization of the aforementioned computing resources to generate data and to send data to other computing devices may impact the overall performance of the computing resources.

### SUMMARY

In general, in one aspect, the invention relates to a method for managing data. The method includes obtaining, by a data management system, a client request from a client to use a microservice, and, in response to the request: identifying a microservice entry associated with the client request, wherein the microservice entry specifies a microservice, providing a term for the microservice to the client based on the microservice entry, obtaining acceptance of the term from the client, and initiating access between the client and a local data system associated with the microservice based on the acceptance.

In one aspect, a non-transitory computer readable medium in accordance with one or more embodiments of the invention includes computer readable program code, which when executed by a computer processor enables the computer processor to perform a method for managing data. The method includes obtaining, by a data management system, a client request from a client to use a microservice, and, in response to the request: identifying a microservice entry associated with the client request, wherein the microservice entry specifies a microservice, providing a term for the microservice to the client based on the microservice entry, obtaining acceptance of the term from the client, and initiating access between the client and a local data system associated with the microservice based on the acceptance.

In one aspect, a system in accordance with one or more embodiments of the invention includes a processor and memory which includes instructions, which when executed by the processor, perform a method for managing data. The method includes obtaining, by a data management system, a client request from a client to use a microservice, and, in response to the request: identifying a microservice entry associated with the client request, wherein the microservice entry specifies a microservice, providing a term for the microservice to the client based on the microservice entry, obtaining acceptance of the term from the client, and initiating access between the client and a local data system associated with the microservice based on the acceptance.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a local data system in accordance with one or more embodiments of the invention.

FIG. 1C shows a diagram of a data management system in accordance with one or more embodiments of the invention.

FIG. 2A shows a flowchart for managing local data system access in accordance with one or more embodiments of the invention.

FIG. 2B shows a flowchart for managing microservice use operations in accordance with one or more embodiments of the invention.

FIG. 2C shows a flowchart for managing a metadata repository in accordance with one or more embodiments of the invention.

FIGS. 3A-3B show an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for providing microservices and terms for use of the microservices to clients. More specifically, embodiments of the invention include using a data management system that communicates with the client by providing terms to the client for accessing computing resources of a local data system. The client may accept one or more of the terms, and, in response, the data management system may provide access information to the client and term information to the local data system. The local data system may enforce the access to the computing resources by the client based on the obtained term information.

Embodiments of the invention include obtaining usage information by the data management system from local data systems. The usage information may specify use of the computing resources of the local data systems. The usage information may be used to update terms for providing microservices for future transactions.

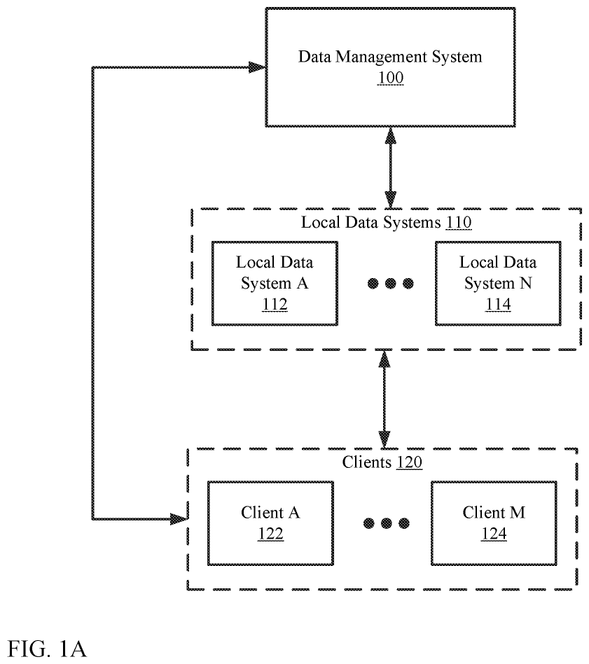

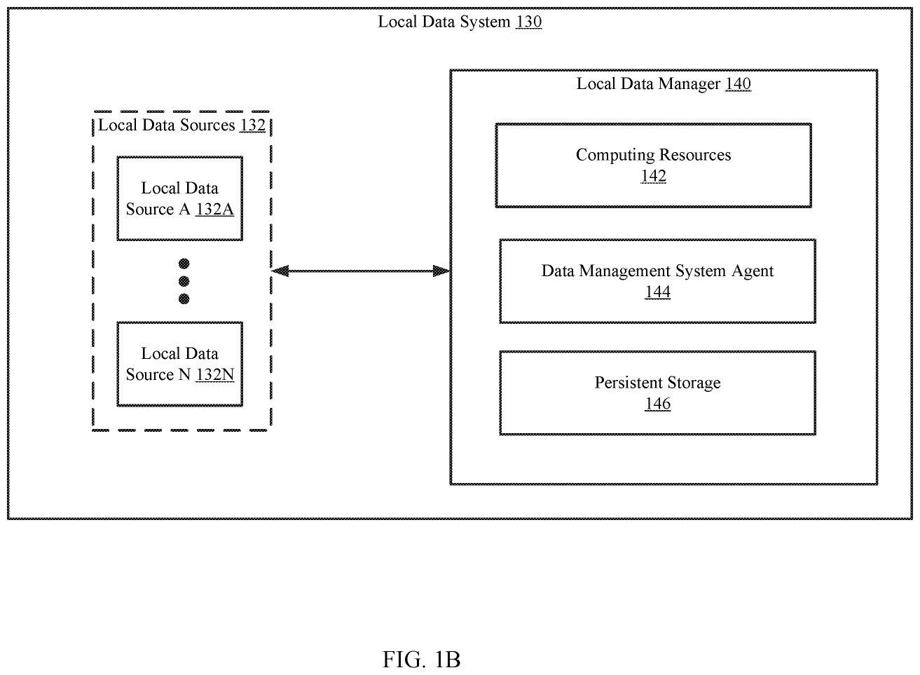

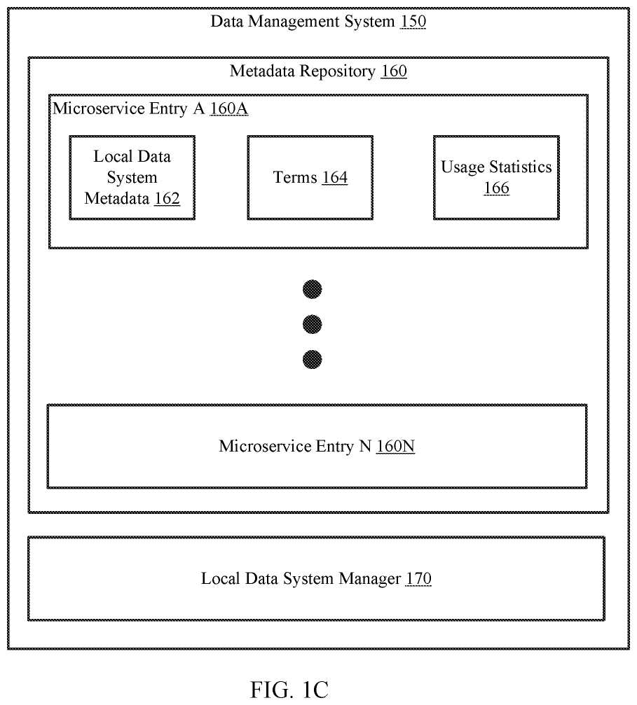

FIG. 1A shows a diagram of a system in accordance with one or more embodiments of the invention. The system includes a data management system (100), local data systems (110), and clients (120). Each component of the system may be operably connected via any combination of wired and/or wireless connections. Each component of the system illustrated in FIG. 1A is discussed below.

In one or more embodiments of the invention, the data management system (100) is a device that facilitates the use of microservices. A microservice may enable a client (122, 124) to: (i) access data on the local data systems, (ii) access applications executing on the local data systems, and/or (iii) access other functionality provided by a local data system (112, 114). The data management system (100) may facilitate the use of the microservices by the clients by providing a platform through which the client and the local data systems can agree to terms for access to or use of the local data systems (or portions thereof). For additional details regarding microservices, see, e.g., FIG. 1B or FIG. 1C.

In one or more embodiments of the invention, the communication between the data management system (100) and the clients (120) includes participating in any type of distributed transaction ledger, e.g., blockchain based transaction, to complete the acceptance of the terms. A distributed transaction ledger may be a program executed by the data management system (100) and/or other entities that creates a record of and/or enforces agreed upon transactions. The record generated by the distributed transaction ledger may be a data structure that is distributed across any number of entities which creates an immutable record of each transaction processed by the distributed transaction ledger. The data management system (100) may complete transactions via other methods than participation in a distributed transaction ledger without departing from the invention.

In one or more embodiments of the invention, the data management system (100) facilitates transactions using smart contracts. A smart contract may be a program executing via a distributed transaction ledger that facilitates the exchange of a currency (e.g., bitcoins) supported by the distributed transaction ledger and a microservice by the local data systems (110). Upon execution of a smart contract, the smart contract may automatically exchange the currency and any access information, associated with the microservice, between the parties that entered into the smart contract.

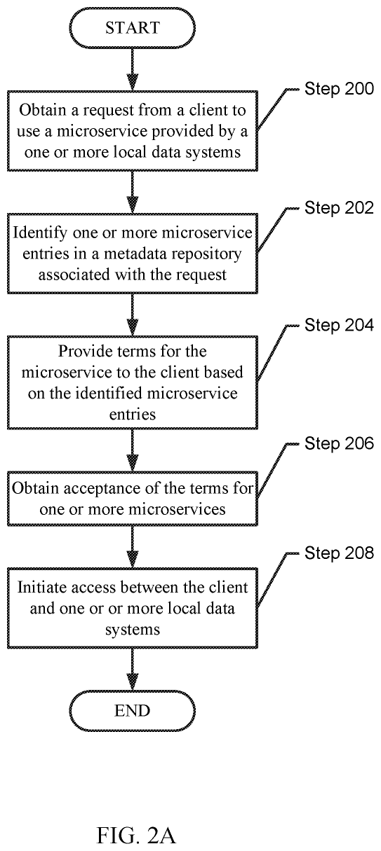

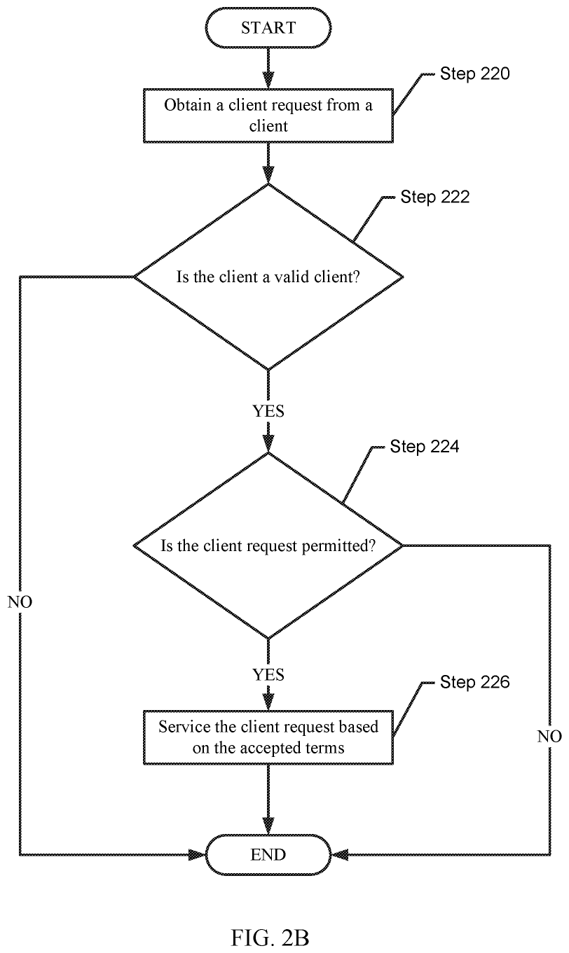

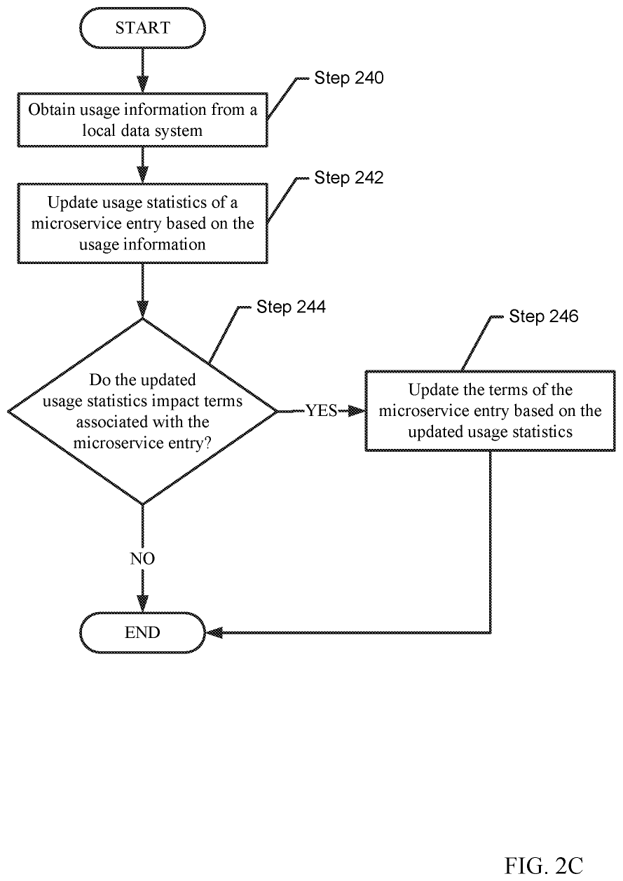

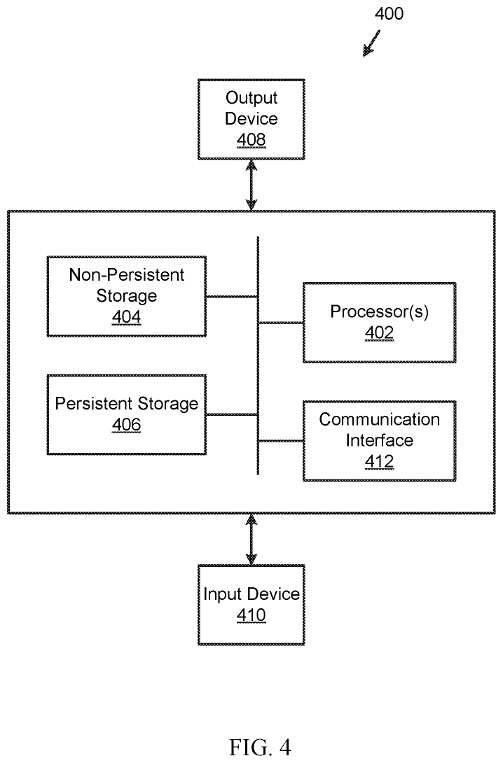

In one or more embodiments of the invention, the data management system (100) is implemented as a computing device (see, e.g., FIG. 4). The computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the data management system (100) described in this application and/or all, or portion, of the methods illustrated in FIGS. 2A-2C.

The data management system (100) may be implemented as a logical device without departing from the invention. The logical device utilizes computing resources of any number of physical computing devices to provide the functionality of the data management system (100) described throughout this application and/or all, or portion, of the methods illustrated in FIGS. 2A-2C. For additional details regarding the data management system, see, e.g., FIG. 1C.

In one or more embodiments of the invention, the local data systems (110) are systems that obtain data, store data, and/or execute applications based on the stored data. The local data systems (110) may provide the stored data and/or applications to the clients (120) as specified by terms agreed to by the clients (120) based on transactions between the clients (120) and the local data systems (110).

In one or more embodiments of the invention, each local data system (110) is implemented as a computing device (see, e.g., FIG. 4). A computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the local data system (110) described throughout this application and/or all, or portion, of the method illustrated in FIG. 2B.

A local data system (112, 114) may be implemented as a logical device without departing from the invention. The logical device utilizes computing resources of any number of physical computing devices to provide the functionality of the local data system (112, 114) described throughout this application and/or all, or portion, of the method illustrated in FIG. 2B. For additional details regarding a local data system (112, 114), see, e.g., FIG. 1B.

In one or more embodiments of the invention, the clients (120) may utilize computing resources and/or access data of the local data systems (110) based on terms established between the clients (120) and the local data systems (110). The clients (120) may communicate with the data management system (100) to agree upon terms for accessing the computing resources.

In one or more embodiments of the invention, each client (122, 124) is implemented as a computing device (see, e.g., FIG. 4). A computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the client (122, 124) described throughout this application.

A client (122, 124) may be implemented as a logical device without departing from the invention. The logical device utilizes computing resources of any number of physical computing devices to provide the functionality of the client (122, 124) described throughout this application.

FIG. 1B shows a diagram of a local data system in accordance with one or more embodiments of the invention. The local data system (130) may be similar to a local data system (112, 114) discussed above. As discussed above, the local data system may obtain data, store data, and execute applications. To perform the aforementioned functionality, the local data system (130) includes local data sources (132) and a local data manager (140). The local data sources (132) and the local data manager (140) may be operably connected via any combination of wired and/or wireless networks without departing from the invention. The local data system (130) may include additional, fewer, and/or different components without departing from the invention. Each of the aforementioned components is discussed below.

In one or more embodiments of the invention, the local data sources (132) are sources of data obtained from real-world processes. A data source may be, for example, a sensor. The sensor may be a hardware device for supplying data regarding a real-world process. For example, the sensor may be a count sensor that determines the number of items that are present in a particular location. The count sensor may supply the number of items to a database that stores the information on behalf of the count sensor. The sensor may be other types of sensors (e.g., distance sensors, temperature sensors, cameras, audio sensors, etc.) without departing from the invention.

In one or more embodiments of the invention, at least one of the local data sources (132A, 132N) is an Internet of things (IOT) device. For example, one of the data sources (132A) may be a camera operably connected to the Internet and that supplies data via an IOT standard to the local data manager (140). The data may be a video stream of a particular location. Image recognition may be utilized to extract relevant information from the video stream. The relevant information may be supplied to the local data manager (140) in isolation or in combination with the video stream itself.

In one or more embodiments of the invention, the local data manager (140) is a device (e.g., a computing device as shown in FIG. 4) that manages data obtained from the local data sources (132). The local data manager (140) may manage the data by storing the data in persistent storage (146) and/or providing the data to external entities (e.g., clients). The local data manager (140) includes computing resources (142), a data management system agent (144), and persistent storage (146). The local data manager may include additional, fewer, and/or different components without departing from the invention.

In one or more embodiments of the invention, the computing resources (142) are resources (e.g., processing, storage, volatile memory, and/or network connections) used by the local data manager (140) to perform various functions of the local data manager as well as to provide microservices to the external entities. In one or more embodiments of the invention, a microservice specifies computing resources to be provided by one or more local data systems (110) to the external entity. A microservice may enable, subject to a smart contract, an algorithm or executable program obtained from (or provided by) the client device to be executed by the computing resources (142). Alternatively, the algorithm or executable program is provided by the computing resources (142) and may be accessed by the client in accordance with the microservice.

Alternatively, a microservice may enable, subject to a smart contract, access to the data obtained from the local data sources (132), which may be stored in the persistent storage (146). The access may include allowing a client to have read only access of the data, have read/write access to the data, make copies of the data for storage on the client (or in another location external to the local data system), any other access, or any combination thereof

In one or more embodiments of the invention, the data management system agent (144) communicates with the data management system and interfaces with other external entities (e.g., clients). The data management system agent (144) may communicate with the data management system by obtaining accepted terms (e.g., the terms specified in the smart contract) from the data management system that specify the access to the computing resources (142) and/or the persistent storage (146) by external entities (e.g., clients). The data management system agent (144) may further communicate with the data management system by providing usage information to the data management system that specifies usage of the computing resources (142) by clients interacting with the local data manager.

The data management system agent (144) may interface with external entities by providing the external entities with the access to the computing resources (142) and/or to the persistent storage (146) as specified by the obtained terms. The data management system agent (144) may enforce the accepted terms. The data management system agent (144) may, for example, allow a client to utilize an algorithm executed by the computing resources (142) of the local data manager (140) and to store the results of the algorithm in a persistent storage of the client. The data management system agent (144) may be programmed to remove the access in accordance with the accepted terms (e.g., after a predetermined time window specified in the terms has elapsed). The invention is not limited by the aforementioned examples.

In one or more embodiments of the invention, the data management system agent (144) is a hardware device including circuitry. The data management system agent (144) may be, for example, a digital signal processor, a field programmable gate array, or an application specific integrated circuit. The data management system agent (144) may be other types of hardware devices without departing from the invention.

In one or more embodiments of the invention, the data management system agent (144) is implemented as computing code stored on a persistent storage that when executed by a processor of the local data manager (140) performs the functionality of the data management system agent (144). The processor may be a hardware processor including circuitry such as, for example, a central processing unit or a microcontroller. The processor may be other types of hardware devices for processing digital information without departing from the invention.

The persistent storage (146) may be configured to store data. The persistent storage (146) may be a physical storage. For example, the persistent storage (146) may include hard disk drives, solid state drives, and/or tape drives for storing data. The persistent storage (146) may include other types of non-transitory storage mediums without departing from the invention.

In one or more embodiments of the invention, the persistent storage (146) stores data obtained from the local data sources (132). The data stored in the persistent storage (146) may be accessed by the external entities (e.g., clients and/or the data management system) based on the terms enforced by the data management system agent (144).

FIG. 1C shows a diagram of a data management system in accordance with one or more embodiments of the invention. The data management system (150) may be similar to the data management system (100, FIG. 1) discussed above. The data management system (150) may include a metadata repository (160) and a local data system manager (170). The data management system (150) may include additional, fewer, and/or different components without departing from the invention. Each component of the data management system (150) illustrated in FIG. 1C is discussed below.

In one or more embodiments of the invention, the metadata repository (160) includes a number of microservice entries (160A, 160N). Each microservice entry may include local data system metadata (162), terms (164), and usage statistics (also referred to as usage information) (166). Each microservice entry (160A, 160N) may include additional, fewer, and/or different data structures (or content) without departing from the invention. Each data structure illustrated for a microservice entry (160A) is discussed below.

In one or more embodiments of the invention, local data system metadata (162) is a data structure that specifies information about one or more local data systems. Information of a local data system may include, for example, a geographical location, types of local data sources (e.g., a type of sensor), metadata about the data stored by the local data system, applications (e.g., algorithms) executable by the local data system, etc. The local data system metadata may include other types of information without departing from the invention. Further, there may be microservice entries associated with each local data system. For example, if the local data system supports an access microservice and a computation mircoservice, the metadata repository may include one entry from the access microservice and another entry for the computation micro service. Further, in another embodiment of the invention, a given local data system may include multiple access microservices, where each of the access services is associated with a different portion of the data stored in the local data system. The invention is not limited to the aforementioned examples.

Continuing with the discussion of FIG. 1C, in one or more embodiments of the invention, the terms (164) specify terms for accessing the local data system. The terms may include, for example, a price and a time window for the access, and a type of access allowed. For example, a term may specify accessing a portion of the data stored in a local data system for 30 days at a price of 50 United States Dollars (USD).

In one or more embodiments of the invention, the usage statistics (166) include information about usage of computing resources associated with the local data system metadata (162). The usage statistics (166) may specify, for example, an amount of computing resources of a local data system being used by a client(s), an amount of available computing resources for additional clients, a historical data structure that tracks previous usage of the computing resources over a previous time period, and/or other usage information without departing from the invention.

In one or more embodiments of the invention, the local data system manager (170) communicates with clients and/or local data systems. The local data system manager (170) may communicate with the clients by providing terms to the clients in response to requests by the clients to utilize computing resources of one or more local data systems. The local data system manager (170) may send credential information and/or additional access information associated with computing resources of the local data systems to the clients in response to the acceptance of terms by the clients.

In one or more embodiments of the invention, the local data system manager (170) communicates with the local data systems by obtaining information about the microservices on the local data systems (e.g., which microservices are available), usage information associated with the computing resources of the local data systems, and/or additional or different information. The usage information may be used to update usage statistics (e.g., 166) of one or more microservice entries.

In one or more embodiments of the invention, the local data system manager (170) is a hardware device including circuitry. The local data system manager (170) may be, for example, a digital signal processor, a field programmable gate array, or an application specific integrated circuit. The local data system manager (170) may be other types of hardware devices without departing from the invention.

In one or more embodiments of the invention, the local data system manager (170) is implemented as computing code stored on a persistent storage that when executed by a processor (e.g., a processor of the data management system) performs the functionality of the local data system manager (170). The processor may be a hardware processor including circuitry such as, for example, a central processing unit or a microcontroller. The processor may be other types of hardware devices for processing digital information without departing from the invention.

FIGS. 2A-2C show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 2A-2C may be performed in parallel with any other steps shown in FIGS. 2A-2C without departing from the scope of the invention.

FIG. 2A shows a flowchart for managing access to local data systems in accordance with one or more embodiments of the invention. The method shown in FIG. 2A may be performed by, for example, a data management system (100, FIG. 1A). Other components of the system illustrated in FIG. 1A may perform the method of FIG. 2A without departing from the invention.

Turning to FIG. 2A, in step 200, a request is obtained from a client to use a microservice provided by one or more local data systems. The request may specify the microservice or characteristics of a microservice that the client would like to use. The request may specify the type of data (at any level of granularity), the type of access to data being requested, the type of computing resources (at any level of granularity), any other information, or any combination thereof.

In step 202, one or more microservice entries are identified in a metadata repository associated with the request. In one or more embodiments of the invention, the microservice entries are identified using the information specified in the request. The data management system may search the metadata repository to identify entries where local data system metadata corresponds to data and/or computing resources specified in the request.

For example, a request may specify a database stored in a local data system. The data management system may search for microservice entries that specify the database in the local data system metadata of the microservice entries.

In step 204, terms for the microservices identified in step 202 are provided to the client based on the identified microservice entries. In one or more embodiments of the invention, the terms are presented to the clients as options (e.g., selections). Each of terms may be associated with a different microservice entry.

In one or more embodiments of the invention, the client makes a selection of one or more terms obtained from the data management system. The client may send (or otherwise provide) the selection of the terms as accepted terms. For example, the client may be presented with a graphical user interface that shows the various terms and that prompts the user of the client to accept the terms, e.g., by clicking a button on the user interface. Any other method for accepting the terms may be used without departing from the invention.

In step 206, acceptance of terms is obtained from the client for one or more microservices. The acceptance may be memorialized in a smart contract (as discussed above).

Once the terms are accepted, in step 208, access between the client and one or more local data systems is initiated. In one or more embodiments of the invention, the access is initiated by sending the client credential information (e.g., a username and a password) that allows the client to access the computing resources of the local data systems. The access may be further initiated by sending the accepted terms to the local data systems. The accepted terms may specify the credential information sent to the client and the computing resources to be accessed by the client.

In one or more embodiments of the invention, the access is initiated by sending the client information for how to access the local data system. The information may be, for example, a connection path that connects the client to a local data manager of the local data system. Other methods for facilitating access to the local data system by the client may be used without departing from the invention.

FIG. 2B shows a flowchart for managing access to local data systems in accordance with one or more embodiments of the invention. The method shown in FIG. 2B may be performed by, for example, a local data manager (140, FIG. 1B). Other components of the system illustrated in FIG. 1B or FIG. 1A may perform the method of FIG. 2B without departing from the invention.

In step 220, a client request is obtained from the client. The client request may specify a request to use a microservice by the client. The client request may include credential information associated with the client (e.g., credential information that was obtained as part of the method in FIG. 2A).

In step 222, a determination is made about whether the client is a valid client. In one or more embodiments of the invention, the determination is made using credential information specified in the client request. The credential information may be compared to obtained access information that specifies credential information of one or more clients. The client may be a valid client if the credential information is present in the obtained access information. If the client is a valid client, the method proceeds to step 224; otherwise, the method ends following step 222.

In step 224, a determination is made about whether the client request is permitted. In one or more embodiments of the invention, the client request is permitted based on the access information. The client request may not be permitted if the terms requested in the client request, for example, have expired or if the client is requesting access to data or computing resources of the local data manager that is not covered by the terms. If the client request is permitted, the process proceeds to step 226; otherwise, the process ends (i.e., the request is denied).

In step 226, the client request is serviced based on the accepted terms.

In one embodiment of the invention, the client request is serviced by allowing the client to access data stored in the local data manager in accordance with the agreed upon terms. In this embodiment the microservice may be an access microservice.

In another embodiment of the invention, the client request is serviced by allowing the client to access computing resources of the local data manager in accordance with the term information associated with the client request. In this embodiment the microservice may be a computation microservice. The term information (i.e., the agreed upon terms) may specify the computing resources to permit the client to use, the data that may be used with the computing resources, and a time window in which the local data manager provides the computing resources and the data access. The local data manager may track the use of the computing resources and data by the client in accordance with the term information and remove access to computing resources and data if or when the client's access or use is not in compliance with the term information.

For example, a microservice may specify allowing a client to execute an application using computing resources of the local data manager. The local data manager may track the use of the computing resources to allow the client to execute the application specified in terms of the microservice. If the local data manager determines that the client attempts to use the computing resources to execute a second algorithm not specified by the terms of a microservice, the local data manager may remove access to the computing resources that the client is attempting to access to execute the second algorithm. The invention is not limited to the above examples.

As discussed above, the local data manager may be programmed to remove access to the computing resources and/or data after the time window provided to the client has elapsed. In this manner, the client ceases to have access for a time period longer than that specified in the terms.

FIG. 2C shows a flowchart for managing access to local data systems in accordance with one or more embodiments of the invention. The method shown in FIG. 2C may be performed by, for example, a data management system (100, FIG. 1A). Other components of the system illustrated in FIG. 1A may perform the method of FIG. 2C without departing from the invention.

In step 240, usage information is obtained from a local data system. In one embodiment of the invention, the usage information is obtained in response to a usage request sent by the data management system to the local data system. The usage request may specify that the local data system provide the usage of computing resources and data of the local data system by one or more clients to the data management system.

In another embodiment of the invention, the usage information is obtained in response to a policy implemented by the local data system. The policy may specify sending usage information periodically to the data management system. Alternatively, the policy may specify sending usage information in response to a threshold usage of computing resources by one or more clients. For example, the local data manger, while tracking the computing resource usage by one or more clients, may determine that a computing resource threshold is exceeded by one or more clients. The determination may trigger the local data system to send the usage information. Additional, different, and/or other mechanisms may be used to provide usage information to the data management system without departing from the invention.

In step 242, usage statistics of one or more microservice entries are updated based on the usage information. In one or more embodiments of the invention, the usage statistics are updated by identifying one or more microservice entries associated with the usage information. The microservice entries may be identified by, for example, identifying the local data system specified in the usage information and identifying local data system metadata of each microservice entry that specifies the identified local data system.

In step 244, a determination is made about whether the updated usage statistics impact the terms associated with the microservice entry. In one or more embodiments of the invention, the determination is made based on the significance of the change of the usage statistics caused by the update. For example, if the updated usage statistics indicate a significant increase of computing resources associated with the microservice entry, the data management system may determine the updated usage statistics impact the terms. If the updated usage statistics impact the terms, the method proceeds to step 246; otherwise, the method ends following step 244.

In step 246, the terms of the microservice entry is updated based on the updated usage statistics. In one or more embodiments of the invention, the terms are updated by increasing a price specified by the terms if the updated usage statistics indicate a higher use of computing resources than previously-stored usage statistics. Conversely, the price may be decreased if the updated usage statistics indicate a significantly lower use of computing resources.

### Example

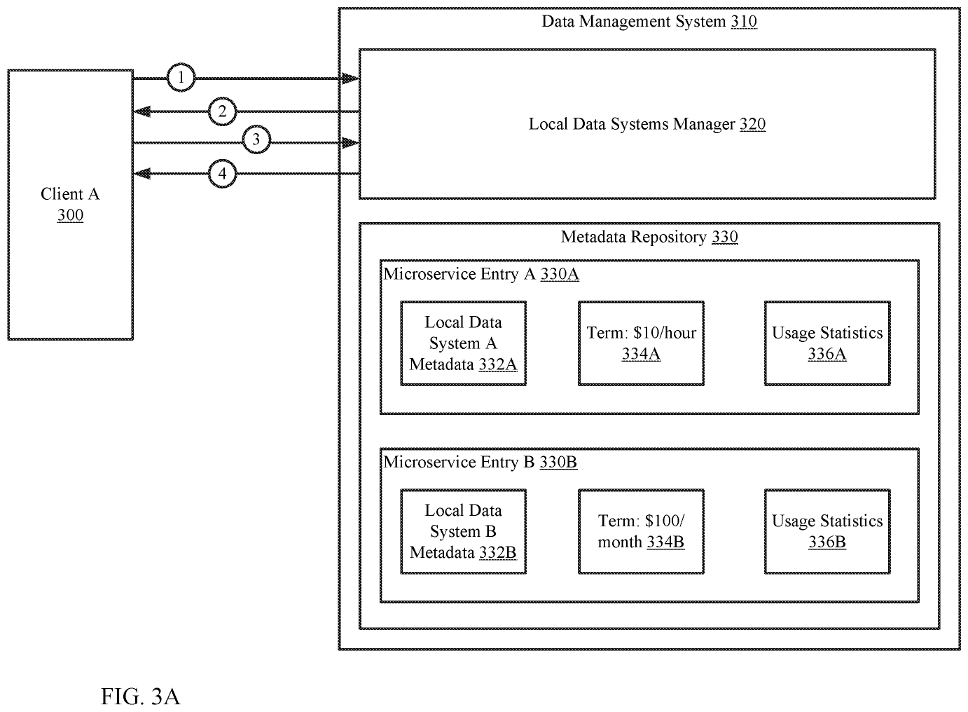

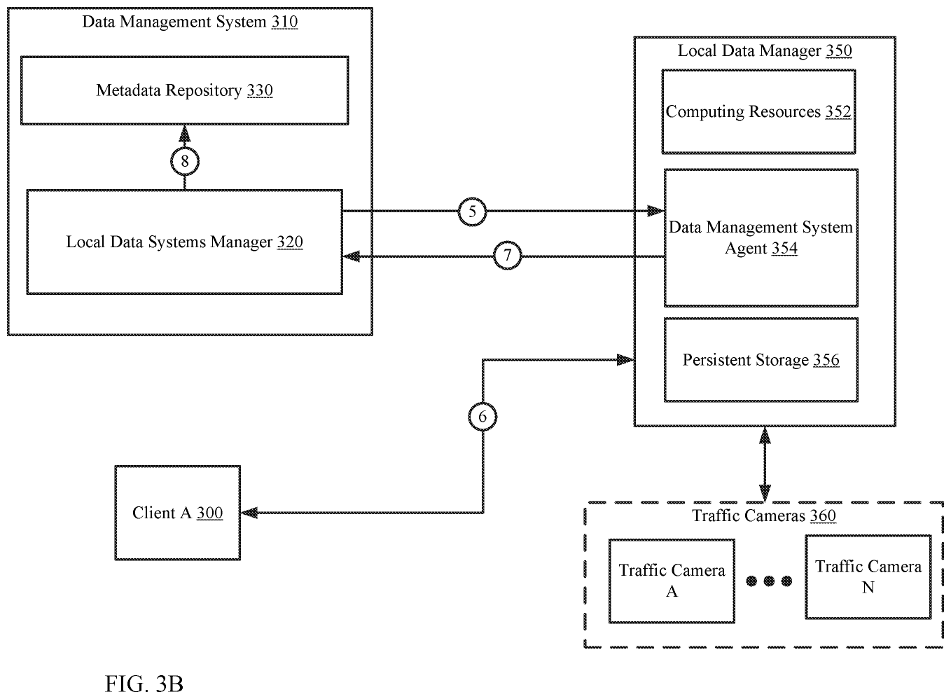

The following section describes an example. The example, illustrated in FIGS. 3A-3B, is not intended to limit the invention. Turning to the example, consider a scenario in which a client would like to implement an algorithm on data that is locally stored in from one or more local data systems. The data may be data obtained by a traffic camera from any geographical location.

FIG. 3A shows an example system in accordance with one or more embodiments of the invention. The system includes a client (300) communicating with a local data system manager (320) of a data management system (310). The client may send a request to the local data system manager (320) to access data associated with a traffic camera [1]. The local data system manager (320) may search a metadata repository (330) of the data management system (310) to identify microservice entries (330A, 330B) associated with the requested data. The identified microservice entries (330A, 330B) may include local data system metadata (332A, 332B) that each specifies a local data system and data associated with a traffic camera. The local data system manager (320) may send terms (334A, 334B) associated with the microservice entries (330A, 330B) to the client (300) for review by the client (300) [2].

The client, after reviewing the terms, may select the term for microservice A based on an expected usage of the data. The expected usage may be for a time period of 1 hour. The client may send the selection to the local data system manager (320) as an acceptance of the selected term [3].

The local data system manager (320), in response to the acceptance of the term, may send access information to the client that specifies how to access the local data system [4]. The access information may be a hyperlink sent via email to the client. The hyperlink may provide the client a path for connecting to a local data manager of local data system A.

The local data system manager (320) may provide term information to the local data manager (350), as seen in FIG. 3B [5]. A data management system (354) of the local data manager (350) may enforce the terms specified in the term information.

At a later point in time, the client may communicate with the local data manager to access the computing resources (352) of the local data manager (350) as specified by the accepted terms [6]. The client may send a client request that includes credential information to confirm the client has the requested access. The data management system agent (354) may identify the credential information from previously stored information to confirm that the client (300) is a valid client.

After confirming the client is a valid client, the data management system agent (354) may determine whether the client request is permitted. The client request may specify using computing resources (352) to run an algorithm on data obtained by traffic cameras (360) stored in the persistent storage (356) of the local data manager (350). The local data manager may determine, based on the term information obtained from the data management system (310), that the request is permitted.

After the above determination, the data management system agent (354) may enforce the terms to allow the client (300) to run the algorithm on the local data manager (350) for one hour. After one hour has elapsed, the data management system agent (354) may remove access to the computing resources (352) by the client (300).

At a later point in time, the data management system agent (354) may provide usage information of the computing resources to the local data system manager (320) of the data management system (310) [7]. The usage information may specify an amount of computing resources (352) used by the client (300) and may specify the data used by the client (300).

The local data system manager (320) may use the usage information to update the metadata repository (330) [8]. Specifically, the local data system manager (320) may update usage statistics (336A) of a microservice entry (330A) associated with the usage information. The local data system manager (320) may use the updated usage statistics to determine that the usage information impacts the terms of a microservice entry. The updated usage statistics may specify that the data obtained from the traffic cameras (360) may be more valuable than what is stated in the terms. Consequently, the terms (334A) of the microservice entry (330A) may be increased to a higher price by the local data system manager (320).

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of a distributed environment of one or more computing devices. More specifically, embodiments of the invention improve the operations of managing computing resource use of a computing device by a second computing device.

Embodiments of the invention may use a third computing device to establish terms for the access of the computing resources. The second computing device may enforce the established terms as the first computing device accesses the computing resources of the second computing device. In this manner, transactions engaged by two computing devices may be implemented by a third computing device.

Thus, embodiments of the invention may address the problem of inefficient use of computing resources in a distributed environment. This problem arises due to the technological nature of the distributed environment.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A method for managing data, the method comprising:
obtaining, by a data management system, a client request from a client to use a microservice;
in response to the request:
identifying a microservice entry associated with the client request, wherein the microservice entry specifies a microservice;
providing a term for the microservice to the client based on the microservice entry;
obtaining acceptance of the term from the client; and
initiating access between the client and a local data system associated with the microservice based on the acceptance,
wherein the local data system comprises a local data manager and a local data source,
wherein the local data source is an internet of things (IoT) device, and
wherein acceptance of the term comprises an exchange of a currency using a distributed transaction ledger.

2. The method of claim 1, further comprising:
obtaining usage information from the local data system;
updating usage statistics of the microservice entry based on the usage information to obtain updated usage statistics;
making a first determination that the updated usage statistics impact the term for a microservice; and
updating the term of the microservice entry based on the updated usage statistics.

3. The method of claim 1, wherein initiating access between the client and the local data system comprises:
sending term information to the local data system, wherein the term information comprises the term; and
sending credential information to the client, wherein the credential information enables the client to access the local data system.

4. (canceled)

5. The method of claim 1, wherein the microservice provides access to data stored in the local data manager.

6. The method of claim 5, wherein the data is obtained from the local data source.

7. The method of claim 1, wherein the microservice provides access to a computing resource of the local data manager.

8. A non-transitory computer readable medium comprising computer readable program code, which when executed by a computer processor enables the computer processor to perform a method, the method comprising:
obtaining, by a data management system, a client request from a client to use a microservice;
in response to the request:
identifying a microservice entry associated with the client request, wherein the microservice entry specifies a microservice;
providing a term for the microservice to the client based on the microservice entry;
obtaining acceptance of the term from the client; and
initiating access between the client and a local data system associated with the microservice based on the acceptance,
wherein the local data system comprises a local data manager and a local data source,
wherein the local data source is an internet of things (IoT) device, and
wherein acceptance of the term comprises an exchange of a currency using a distributed transaction ledger.

9. The non-transitory computer readable medium of claim 8, further comprising:
obtaining usage information from the local data system;
updating usage statistics of the microservice entry based on the usage information to obtain updated usage statistics;
making a first determination that the updated usage statistics impact the term for a microservice; and
updating the term of the microservice entry based on the updated usage statistics.

10. The non-transitory computer readable medium of claim 8, wherein initiating access between the client and the local data system comprises:
sending term information to the local data system, wherein the term information comprises the term; and
sending credential information to the client.

11. (canceled)

12. The non-transitory computer readable medium of claim 8, wherein the microservice provides access to data stored in the local data manager.

13. The non-transitory computer readable medium of claim 12, wherein the data is obtained from the local data source.

14. The non-transitory computer readable medium of claim 8, wherein the microservice provides access to a computing resource of the local data manager.

15. A system, comprising:
a processor; and
memory comprising instructions, which when executed by the processor, perform a method, the method comprising:
obtaining, by a data management system, a client request from a client to use a microservice;
in response to the request:
identifying a microservice entry associated with the client request, wherein the microservice entry specifies a microservice;
providing a term for the microservice to the client based on the microservice entry;
obtaining acceptance of the term from the client; and
initiating access between the client and a local data system associated with the microservice based on the acceptance,
wherein the local data system comprises a local data manager and a local data source,
wherein the local data source is an internet of things (IoT) device, and
wherein acceptance of the term comprises an exchange of a currency using a distributed transaction ledger.

16. The system of claim 15, the method further comprising:
obtaining usage information from the local data system;
updating usage statistics of the microservice entry based on the usage information to obtain updated usage statistics;
making a first determination that the updated usage statistics affect impact the term for a microservice; and
updating the term of the microservice entry based on the updated usage statistics.

17. The system of claim 15, wherein initiating access between the client and the local data system comprises:
sending term information to the local data system, wherein the term information comprises the term; and
sending credential information to the client, wherein the credential information enables the client to access the local data system.

18. (canceled)

19. The system of claim 15, wherein the microservice provides access to data stored in the local data manager and wherein the data is obtained from the local data source.

20. The system of claim 15, wherein the microservice provides access to a computing resource of the local data manager.
